(19) United States
(12) Patent Application Publication
(10) Pub. No.: US 2026/0199851 A1
(43) Pub. Date: Jul. 16, 2026

(54) Container Stirring Structure

(71) Applicant: Huizhou Victory Technology Ltd, Huizhou City (CN)

(72) Inventor: Hesheng Liu, Huaihua City (CN)

(73) Assignee: Huizhou Victory Technology Ltd, Huizhou City (CN)

(21) Appl. No.: 19/090,826

(22) Filed: Mar. 26, 2025

(30) Foreign Application Priority Data
Jan. 14, 2025 (CN) 202510052465.X

(51) Int. Cl. B01F 33/453; B01F 23/40; B01F 23/43; B01F 35/32; B44F 99/00; H02K 21/22; B01F 35/30

(52) U.S. Cl. CPC B01F 33/4533; B01F 23/43; B01F 23/48; B01F 35/3204; B01F 35/3213; B44F 99/00; H02K 21/22; B01F 2035/351

(57) ABSTRACT

A container stirring structure is provided, which includes a sealing component, a power component, and a stirring component. Liquid is provided in the sealing component, the stirring component is provided in the sealing component, and the stirring component is provided on the power component. The stirring component achieves stirring of liquid in the sealing component through the power component. The design of the present disclosure involves placing the stirring component on the power component, and under the action of the power component, the stirring component begins to stir, thereby achieving an effect of stirring the liquid. This structural design ensures stable stirring of the liquid, and the stirring component will not fall off due to external shaking or other factors, which causes it unable to stir the liquid.

### CROSS-REFERENCE TO RELATED APPLICATIONS

This application claims priority to Chinese Patent Application No. 202510052465.X, filed on January 14, 2025, which is hereby incorporated by reference in its entirety.

### TECHNICAL FIELD

The present disclosure relates to the field of water fetching device technologies, and in particular, to a container stirring structure.

### BACKGROUND

With the development of the times, handicrafts have become common decorations in people's lives, with corresponding themes for different festivals and events. Some existing handicrafts are equipped with water fetching devices, which drive the liquid or decorations inside the handicrafts to start rotating, adding ornamental value to the handicrafts. In the existing technology, such as CN201922317538.6 entitled with a magnetic water fetching device in a craft container, a magnetic water fetching device in a craft container, which includes a water container, and a magnetic drive rotating module set inside the craft. The magnetic drive rotating module includes a silicone rotor, a transparent spacer, a plastic material main rotor, a motor base, and a motor. The main rotor is fixed on the motor output shaft, and the transparent spacer is fixed above the main rotor. After the motor is powered on, the main rotor of the motor begins to rotate, which drives the bottom silicone rotor of the container to rotate and fetch water through magnetic attractions.

However, the method of using magnetic attraction to drive the silicone rotor at the bottom of the container to rotate and fetch water, as mentioned above, may cause the silicone rotor at the bottom of the container to easily detach when subjected to external shaking or shaking, rendering it impossible to continue rotating and fetching water. Furthermore, the traditional motor used for fetching water has a short lifespan and cannot meet the requirements of the product. Therefore, it is necessary to develop a design that can adopt updated technology, which will not be unable to rotate and fetch water due to external shaking, and has a long service life, in order to solve the above problems.

### SUMMARY

The purpose of the present disclosure is to provide a container stirring structure to solve problems mentioned in the background technology, such as a silicone rotor at a bottom of a container easily falling off, rendering it unable to continue rotating to fetch water, and short service life.

The present disclosure provides the following technical solution: a container stirring structure, including a sealing component, a power component, and a stirring component, where the sealing component is provided with liquid, the stirring component is provided in the sealing component, and the stirring component is provided on the power component, the stirring component achieves stirring of the liquid in the sealing component through the power component.

In some embodiments of the present disclosure, the power component is a brushless motor component or a conventional motor component.

In some embodiments of the present disclosure, the brushless motor component includes a stator component and a rotor component, the stator component is provided outside the sealing component and fixedly connected to the sealing component, the rotor component is provided in the sealing component, the stirring component and the rotor component are fixedly connected or integrally formed; the stirring component achieves stirring of the liquid in the sealing component through a rotation of the rotor component.

In some embodiments of the present disclosure, the rotor component includes a rotating magnet, a rotating shaft, and a rotor frame, where the rotating shaft is provided on the rotor frame, and the rotating magnet is provided on the rotating shaft.

In some embodiments of the present disclosure, a support platform is provided at a top of the rotating shaft, and a bottom width of the support platform is greater than a diameter of the rotor component or a diameter of the stirring component.

In some embodiments of the present disclosure, the stator component is provided in the rotor frame, and the stator component is provided outside the sealing component.

In some embodiments of the present disclosure, the rotor frame and the sealing component are fixedly connected or integrally formed.

In some embodiments of the present disclosure, the rotating magnet is a magnetic ring or a magnetic sheet.

In some embodiments of the present disclosure, a motor fixing part is provided at a bottom of the sealing component, and the stator component is fixedly connected to the sealing component through the motor fixing part.

In some embodiments of the present disclosure, the stator component includes a control board and a stator, the control board is connected to the stator, and the control board is connected to an external power source.

In some embodiments of the present disclosure, the stirring component includes a rotating impeller, and the rotating impeller and the rotor component are fixedly connected or integrally formed.

In some embodiments of the present disclosure, the sealing component includes a container body and a container seat, the container body and the container seat form a sealed chamber, and the liquid is provided in the sealed chamber formed by the container body and the container seat.

In some embodiments of the present disclosure, the container seat and the rotor frame are fixedly connected or integrally formed.

In some embodiments of the present disclosure, the stator component is provided outside the sealed chamber formed by the container body and the container seat, and the stator component is provided in the rotor frame.

In some embodiments of the present disclosure, a liquid injection port and a liquid sealing plug are provided on the container seat.

In some embodiments of the present disclosure, a sealing sheet configured to seal is provided between the container body and the container seat.

In some embodiments of the present disclosure, the container body and the container seat are clamping connected or rotatably connected.

In some embodiments of the present disclosure, an internal rotation component is provided in the sealing component, and the internal rotation component is rotated inside the liquid in the sealing component by an overall action of the stirring component and the power component through the flow of the liquid inside the sealing component.

In some embodiments of the present disclosure, a rotation fulcrum is provided on the internal rotation component, and the rotation fulcrum abuts against a top of the container body.

In some embodiments of the present disclosure, the liquid is a mixture of one or a combination of two or more of water, oil, and liquid pigment.

Compared with the existing technology, the beneficial effects of the present disclosure are as follows.

The container stirring structure of the present disclosure includes a sealing component, a power component, and a stirring component. Liquid is provided inside the sealing component, the stirring component is provided in the sealing component, and the stirring component is provided on the power component. The stirring component achieves stirring of liquid in the sealing component through the power component. By placing the stirring component on the power component, the stirring component begins to stir under the action of the power component, achieving the effect of stirring the liquid. This structural design ensures stable stirring of the liquid, and the stirring component will not fall off due to external shaking or other factors, rendering it unable to stir the liquid.

When the power component of the container stirring structure of the present disclosure is a brushless motor, the brushless motor component includes a stator component and a rotor component. The stator component is provided outside the sealing component and is fixedly connected to the sealing component. The rotor component is provided in the sealing component, and the stirring component and the rotor component are fixedly connected or integrally formed. The stirring component stirs the liquid in the sealing component through a rotation of the rotor component. By separating the stator component and rotor, and setting them separately inside and outside the sealing component, and fixedly connecting or integrally forming the stirring component and rotor component, the stirring component stirs the liquid in the sealing component through the rotation of the rotor component. The stirring effect of the liquid can be achieved through the sealing component, rendering a connection between the stirring component and the rotor component more stable and less likely to fall off.

The container stirring structure of the present disclosure uses a brushless motor component to drive the stirring component. Compared with traditional motor structures, the brushless motor structure has a longer service life, meets the needs of product use, and effectively reduces the cost of use.

The container stirring structure and sealing component of the present disclosure include a container body and a container seat, where the container body and the container seat form a sealed chamber, and the liquid is provided in the sealed chamber formed by the container body and the container seat. A liquid injection port and a liquid sealing plug are provided on the container seat. A sealing sheet is provided between the container body and the container seat for sealing. The structural design of the liquid injection port makes it easier and faster to inject liquid into the product. The design of the sealed chamber, sealing plate, and liquid sealing plug ensures that the product has good sealing performance and is not prone to liquid leakage.

The container stirring structure of the present disclosure is provided with an internal rotation component in the sealing component. The internal rotation component is rotated within the liquid inside the sealing component through the overall action of the stirring component and the power component, driven by the flow of liquid inside the sealing component. By providing the internal rotation component, under the action of liquid flow, the internal rotation component will rotate, adding ornamental value to the product and rendering it more beautiful.

In the container stirring structure of the present disclosure, the container body and container seat are clamping connected or rotatably connected. Through the clamping or rotating connection method, the product assembly is faster, and the production efficiency is effectively improved.

### BRIEF DESCRIPTION OF DRAWINGS

In order to provide a clearer explanation of the embodiments or technical solutions in the present application or existing technology, a brief introduction will be given to the accompanying drawings required for the embodiments or existing technology description. It is obvious that the accompanying drawings described below are only some embodiments of the present application. For those skilled in the art, other drawings can be obtained based on these drawings without requiring creative work.

FIG. 1 is a semi-sectional schematic diagram of a container stirring structure of the present disclosure.

FIG. 2 is an exploded schematic diagram of the container stirring structure of the present disclosure, in which a power component is a schematic diagram of a brushless motor component.

Numeral reference: 1-sealing component; 11-container body, 12-container seat; 121-liquid injection port; 122-liquid sealing plug; 2-brushless motor component; 21-stator component; 211-control board; 212-stator; 22-rotor component; 221-rotating magnet; 222- rotating shaft; 223-rotor frame; 3-stirring component; 31-rotating impeller; 4-internal rotation component; 41-rotation fulcrum; 5-sealing sheet; 6- motor fixing part; 7- support platform.

### DESCRIPTION OF EMBODIMENTS

The following provides a detailed description of the embodiments of the present application, examples of which are shown in the accompanying drawings, where the same or similar reference numerals from beginning to end represent the same or similar elements or elements with the same or similar functions. The embodiments described below with reference to the accompanying drawings are exemplary and are only used to explain the present application, and should not be construed as limiting the present application.

In a description of this application, it should be understood that terms "first" and "second" are only used for descriptive purposes and cannot be understood as indicating or implying relative importance or implying the number of technical features indicated. Thus, the features limited to "first" and "second" may explicitly or implicitly include one or more of the aforementioned features. In the description of this application, the meaning of "multiple" refers to two or more, unless otherwise specifically limited.

In the description of this application, it should be noted that unless otherwise specified and limited, terms "installation" and "connection" should be broadly understood, for example, it can be a fixed connection, a detachable connection, or an integrated connection; it can be a mechanical connection, an electrical connection, or communication with each other; it can be directly connected or indirectly connected through an intermediate medium, and it can be a connection within two components or an interaction relationship between two components. For those skilled in the art, the specific meanings of the above terms in this application can be understood according to a specific situation.

In the description of this application, it should be understood that terms "up", "down", "side", "front", "back", etc. indicate orientation or position relationships based on installation, only for the convenience of describing this application and simplifying the description, and do not indicate or imply that the device or component referred to must have a specific orientation, be constructed and operated in a specific orientation, and therefore cannot be understood as a limitation of this application.

In the description of this application, it should be noted that term "and/or" is only a description of the association relationship between related objects, indicating that there can be three types of relationships, such as A and/or B, which can represent: the existence of A alone, the existence of A and B at the same time, and the existence of B alone.

It should be noted that in the embodiments of the present application, the same reference numerals are used to represent the same components or parts. For the same parts in the embodiments of the present application, only one part or component may be marked with a reference numeral in the figure. It should be understood that for other identical parts or components, the reference numerals are also applicable.

In addition, in this application, the technical features described in an open manner include both closed technical solutions composed of the listed features and open technical solutions containing the listed features.

In order to further understand the disclosure content, characteristics, and efficacy of the present application, the following embodiments are listed and explained in detail with the accompanying drawings:

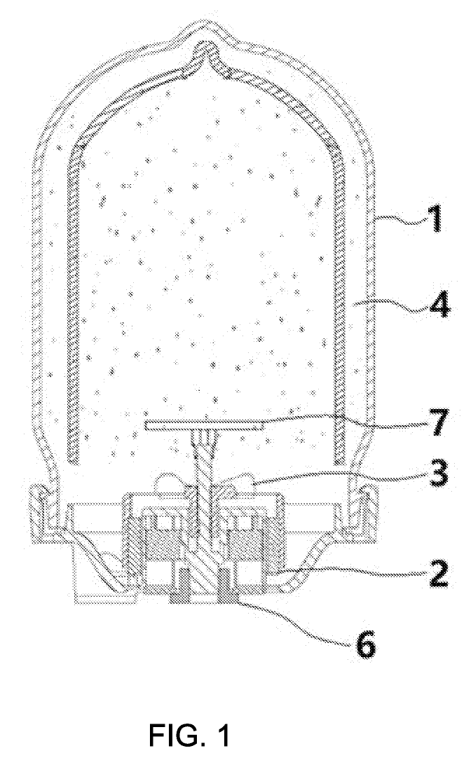

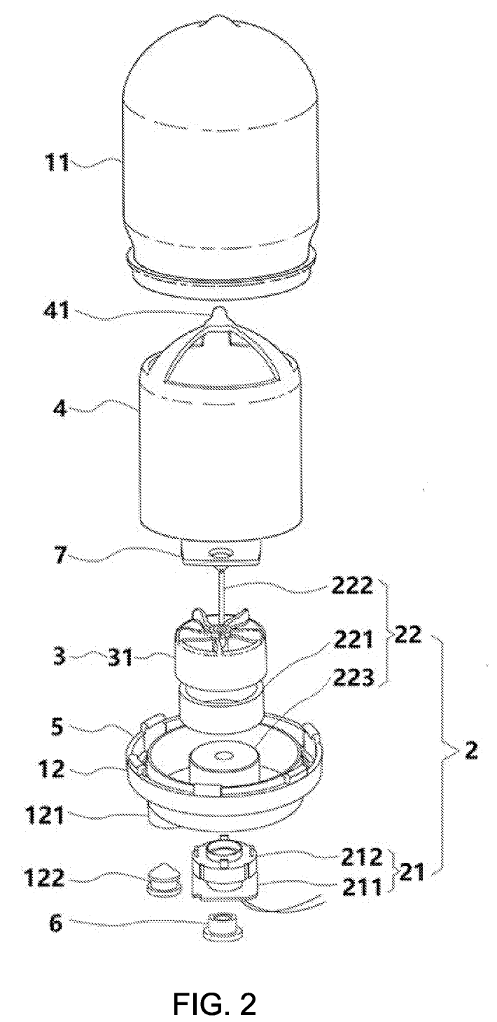

As shown in FIGS. 1-2, a container stirring structure includes a sealing component 1, a power component, and a stirring component 3. The sealing component 1 is provided with liquid, the stirring component 3 is provided in the sealing component 1, and the stirring component 3 is provided on the power component. The stirring component 3 achieves stirring of the liquid in the sealing component 1 through the power component. In this embodiment, through the above structural design, the stirring component is provided on the power component, and under an action of the power component, the stirring component begins to stir, thereby achieving the effect of stirring the liquid. This structural design ensures stable stirring of the liquid, and the stirring component will not fall off due to external shaking or other factors, rendering it unable to draw water. Of course, the above structural design is not limited to this and can also be other structures that can serve the same purpose.

In an implementation mode, the power component is a brushless motor component 2 or a conventional motor component. In this embodiment, the power component is the brushless motor component, which has a longer service life and effectively reduces maintenance costs. Of course, the type of power component is not limited to this and can be other power components that can serve the same purpose.

In an implementation mode, as shown in FIG. 2, the brushless motor component 2 includes a stator component 21 and a rotor component 22. The stator component 21 is provided outside the sealing component and is fixedly connected to the sealing component 1. The rotor component 22 is provided in the sealing component 1. The stirring component 3 is fixedly connected or integrally formed with the rotor component 22. The stirring component 3 stirs the liquid inside the sealing component 1 through a rotation of the rotor component 22. In this embodiment, the stirring component and the rotor component are fixedly connected. By providing the stator component and the rotor inside and outside the sealing component, and designing a structure where the stirring component and the rotor component are fixedly connected or integrated formed, the stirring component stirs the liquid in the sealing component through the rotation of the rotor component. The stirring effect of the liquid can be achieved through the sealing component, rendering the connection between the stirring component and the rotor component more stable and less likely to fall off. Of course, the connection method between components is not limited to this, and other connection methods with the same function can also be used.

In an implementation mode, the rotor component 22 includes a rotating magnet 221, a rotating shaft 222, and a rotor frame 223. The rotating shaft 222 is provided on the rotor frame 223, and the rotating magnet 221 is provided on the rotating shaft 222. In this embodiment, by placing the rotor component on the rotor frame, the rotor component is less likely to fall off inside the sealing component, and the connection is more stable. Of course, the above structural design is not limited to this and can also be other structures that serve the same purpose.

In an implementation mode, a support platform 7 is provided at a top of the rotating shaft 222, and a bottom width of the support platform 7 is greater than a diameter of the rotor component 22 or a diameter of the stirring component 3. In this embodiment, the bottom width of the support platform is greater than the diameter of the rotor component. By providing the support platform, on the one hand, the rotor component and stirring component can be limited to prevent them from falling off easily; on the other hand, the supporting platform can be provided with 'an interior 'scene to make the product more aesthetically pleasing.

In an implementation mode, as shown in FIG. 1, the stator component 21 is provided in the rotor frame 223, and a motor fixing part 6 is provided at a bottom of the sealing component 1. The stator component 21 is fixedly connected to the sealing component 1 through the motor fixing part 6. In this embodiment, the motor fixing part is a T-shaped plug, which fixes the stator component in the rotor frame through the motor fixing part, rendering the stator component less likely to fall off. Of course, the shape of the motor fixing part is not limited to this, and can be other structures or shapes that serve the same purpose.

In an implementation mode, the stator component 21 includes a control board 211 and a stator 212. The control board 211 is connected to the stator 212, and the control board 211 is connected to an external power source. In this embodiment, the control board can generate a magnetic field by energizing the stator component after being connected to the external power source. Of course, the above structural design is not limited to this and can be other structural designs that serve the same purpose.

In an implementation mode, the stirring component 3 includes a rotating impeller 31, which is fixedly connected or integrally formed with the rotor component 22. In this embodiment, the stirring component is the rotating impeller, which is fixedly connected to the rotor component. Through this design, the stirring effect of the liquid is improved. Of course, the above structural design is not limited to this and can also be other structural designs that serve the same purpose.

In an implementation mode, the sealing component 1 includes a container body 11 and a container seat 12. The container body 11 and the container seat 12 form a sealed chamber, and the liquid is provided in the sealed chamber formed by the container body 11 and the container seat 12. In this embodiment, the container body and the container seat form a sealed chamber, and the sealed chamber is filled with liquid, rendering the product more aesthetically pleasing. Of course, the above structural design is not limited to this and can also be other structural designs that serve the same purpose.

In an implementation mode, as shown in FIG. 1, the container seat 12 and the rotor frame 223 are fixedly connected in a sealing manner or integrated. The stator component 21 is provided outside the sealed chamber formed by the container body 11 and the container seat 12, and is provided in the rotor frame 223. In this embodiment, the container seat and the rotor frame are integrally formed, and the container seat and an interior of the rotor frame form a chamber. The stator component is provided in the chamber, outside the container seat. Through this structural design, on the one hand, it facilitates the installation of the stator component, and on the other hand, when the stator component is damaged, only the stator component needs to be replaced, without the need to replace the entire brushless motor component. Of course, the above structural design is not limited to this and can also be other structures that serve the same purpose.

In an implementation mode, the container holder 12 is provided with a liquid injection port 121 and a liquid sealing plug 122. In this embodiment, providing the liquid injection port renders it easier and faster for the product to inject liquid, and providing the liquid seal can prevent liquid leakage and improve sealing performance. Of course, the above structural design is not limited to this and can also be other structural designs that serve the same purpose.

In an implementation mode, a sealing sheet 5 is provided between the container body 11 and the container seat 12 for sealing, which is a sealing rubber ring or a sealing water sheet. In this embodiment, the sealing sheet is a sealing rubber ring, and by providing the sealing ring called a rubber ring, the sealing performance of the sealing component is effectively improved. Of course, the type of sealing sheet is not limited to this, and it can also be other sealing sheets that have the same function.

In an implementation mode, the container body 11 and the container seat 12 are clamping connected or rotatably connected. In this embodiment, the container body and the container seat are clamping connected, which renders the installation of the product more convenient and efficient, thereby effectively improving production efficiency. Of course, the connection method is not limited to this and can also be other connection methods that serve the same purpose.

In an implementation mode, an internal rotation component 4 is provided in the sealing component 1. The internal rotation component 4 is rotated within the liquid in the sealing component 1 through a combined action of the stirring component 3 and the power component, driven by the flow of liquid in the sealing component 1. In this embodiment, by providing the internal rotation component and the overall action of the stirring component and the power component, the liquid flow inside the sealing component drives the internal rotation component to rotate inside the liquid inside the sealing component, thereby increasing the viewing and diversity of the product. Of course, the above structural design is not limited to this and can also be other structural designs that serve the same purpose.

In an implementation mode, the internal rotation component 4 is provided with a rotation fulcrum 41, and the rotation fulcrum 41 abuts against a top of the container body 11. In this embodiment, by providing the rotation fulcrum that abuts against the top of the container body, the internal rotation component can rotate more stably within the sealing component. Of course, the above structural design is not limited to this and can also be other structural designs that serve the same purpose.

In an implementation mode, the liquid is a mixture of one or more combinations of water, oil, and liquid pigments. In this embodiment, the liquid is water, and by injecting water into the sealing component, the product can be made more aesthetically pleasing. Of course, the type of liquid is not limited to this and can be other liquids that have the same effect.

In an implementation mode, the power component is a brushless motor component 2 or a conventional motor component. In this embodiment, the conventional motor component is a brushed motor component, which has a low cost and effectively reduces production costs. Of course, the type of power component is not limited to this and can be other power components that can serve the same purpose.

Working principle: the container stirring structure includes a sealing component, a power component, and a stirring component. The sealing component contains liquid, and the stirring component is provided on the power component. After the power component is powered on, the stirring component begins to stir under the action of the power component, thereby achieving the effect of stirring the liquid. This structural design ensures stable stirring of the liquid, and the stirring component will not fall off due to external shaking or other factors, rendering it impossible to draw water.

When the power component is a brushless motor component, the brushless motor component includes a stator component and a rotor component. The rotor component is provided in the sealing component, and the rotor component includes a rotating magnet, a rotor frame, and a rotating shaft. The rotor frame and the sealing component are fixedly connected or integrally formed. The rotating magnet is provided on the rotor frame, the stator component is provided in the rotor frame, and the stator component is provided outside the sealing component. The stirring component is provided on the rotor component. The stator component is connected to an external power source through a control board. After being powered on, the stator component generates a magnetic field to drive the rotating magnet to rotate, and the rotating magnet drives the stirring component to rotate, thereby achieving the effect of stirring the liquid; when the internal rotation component is provided inside the sealing component, the internal rotation component is rotated under the action of liquid flow. This design separates the motor into two parts: the stator component and the rotor component, which are provided inside and outside the sealing component. The stirring component is provided on the rotor component to stabilize the stirring effect of the liquid. The rotor component and stirring component inside the sealing component will not be affected by external shaking and fall off, thereby effectively solving a problem of the bottom silicone rotor in the sealed container being easily detached and unable to continue pumping water due to external shaking and other factors in the existing technology, and the structural design of the brushless motor has a long service life, thereby meeting the needs of product use.

The various technical features of the above embodiments can be combined in any way. In order to render the description concise, not all possible combinations of the various technical features in the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the present disclosure. It should be pointed out that for those skilled in the art, several modifications and improvements can be made without departing from the inventive concept, which are within the protection scope of the present disclosure. Therefore, the protection scope of the present disclosure patent should be based on the appended claims.

What is claimed is:

1. A container stirring structure, comprising a sealing component, a power component, and a stirring component,
wherein the sealing component is provided with liquid,
the stirring component is provided in the sealing component, and the stirring component is provided on the power component,
the stirring component achieves stirring of the liquid in the sealing component through the power component.

2. The container stirring structure according to claim 1, wherein the power component is a brushless motor component or a conventional motor component.

3. The container stirring structure according to claim 2, wherein the brushless motor component comprises a stator component and a rotor component,
the stator component is provided outside the sealing component and fixedly connected to the sealing component,
the rotor component is provided in the sealing component, the stirring component and the rotor component are fixedly connected or integrally formed;
the stirring component achieves stirring of the liquid in the sealing component through a rotation of the rotor component.

4. The container stirring structure according to claim 3, wherein the rotor component comprises a rotating magnet, a rotating shaft, and a rotor frame,
wherein the rotating shaft is provided on the rotor frame, and the rotating magnet is provided on the rotating shaft.

5. The container stirring structure according to claim 4, wherein a support platform is
provided at a top of the rotating shaft, and a bottom width of the support platform is greater than a diameter of the rotor component or a diameter of the stirring component.

6. The container stirring structure according to claim 4, wherein the stator component is provided in the rotor frame, and the stator component is provided outside the sealing component.

7. The container stirring structure according to claim 4, wherein the rotor frame and the sealing component are fixedly connected or integrally formed.

8. The container stirring structure according to claim 4, wherein the rotating magnet is a magnetic ring or a magnetic sheet.

9. The container stirring structure according to claim 3, wherein a motor fixing part is provided at a bottom of the sealing component, and the stator component is fixedly connected to the sealing component through the motor fixing part.

10. The container stirring structure according to claim 9, wherein the stator component comprises a control board and a stator, the control board is connected to the stator, and the
control board is connected to an external power source.

11. The container stirring structure according to claim 10, wherein the stirring component comprises a rotating impeller, and the rotating impeller and the rotor component are fixedly connected or integrally formed.

12. The container stirring structure according to claim 11, wherein the sealing component
comprises a container body and a container seat, the container body and the container seat form a sealed chamber, and the liquid is provided in the sealed chamber formed by the container body and the container seat.

13. The container stirring structure according to claim 12, wherein the container seat and the rotor frame are fixedly connected or integrally formed.

14. The container stirring structure according to claim 12, wherein the stator component is provided outside the sealed chamber formed by the container body and the container seat,
and the stator component is provided in the rotor frame.

15. The container stirring structure according to claim 13, wherein a liquid injection port and a liquid sealing plug are provided on the container seat.

16. The container stirring structure according to claim 15, wherein a sealing sheet configured to seal is provided between the container body and the container seat.

17. The container stirring structure according to claim 16, wherein the container body and the container seat are clamping connected or rotatably connected.

18. The container stirring structure according to claim 16, wherein an internal rotation
component is provided in the sealing component, and the internal rotation component is rotated
inside the liquid in the sealing component by an overall action of the stirring component and the power component through the flow of the liquid inside the sealing component.

19. The container stirring structure according to claim 18, wherein a rotation fulcrum is provided on the internal rotation component, and the rotation fulcrum abuts against a top of the
container body.

20. The container stirring structure according to claim 19, wherein the liquid is a mixture of one or a combination of two or more of water, oil, and liquid pigment.
